(19) United States
(12) Patent Application Publication
(10) Pub. No.: US 2019/0388816 A1
(43) Pub. Date: Dec. 26, 2019

(54) Melt-Blown Non-Woven Filter Material

(71) Applicant: Qian Huang, Nantong (CN)

(72) Inventor: Qian Huang, Nantong (CN)

(21) Appl. No.: 16/560,972

(22) Filed: Sep. 4, 2019

Related U.S. Application Data
(63) Continuation of application No. PCT/CN2018/102141, filed on Aug. 24, 2018.

(30) Foreign Application Priority Data
Jul. 3, 2018 (CN) 201810718876.8

(51) Int. Cl. B01D 39/16; D01D 5/00

(52) U.S. Cl. CPC B01D 39/1623; D01D 5/0023; B01D 2239/0618; D10B 2331/301; B01D 2239/0631; B01D 2239/065; D10B 2331/041; B01D 2239/0622

(57) ABSTRACT

The invention provides a melt-blown non-woven filter material, which is prepared by the following method: provide a polylactic acid raw material; dissolve the polylactic acid raw material into a DMF solvent; the polylactic acid electrospinning layer is prepared by electrospinning method using polylactic acid spinning solution as raw material; provide polylactic acid raw material again and provide polyphenylene sulfide raw material; and perform surface treatment. Polylactic acid raw material, polyphenylene sulfide raw material, nano-titania powder are mixed well with the processing assistant to obtain a mixture: the mixture is extruded into modified polylactic acid particles; then a modified polylactic acid melt-blown fiber layer is formed on the polylactic acid electrospinning layer by using the melt-blown method. The invention innovatively implements loading, nano-titania particles into the synthetic fiber, which makes the fiber material presented in this invention not only have filtering effects, but also have photocatalytic ability.

### TECHNICAL FIELD

This invention relates to the field of air filtering material, especially a melt-blown non-woven filtering material

### BACKGROUND TECHNOLOGY

As one of the high-efficiency dust-removing devices, bag filter is widely used in flue gas treatment systems of power plants, metallurgy, and waste incineration. The biggest feature of the bag filter is its super-high dust removal efficiency, which is up to 99.9999% in the laboratory, 99.99% in practical applications, and the dust emission concentration is below 10 mg/Nm3, or even reach to 1 mg/Nm3, basically reaching zero emission. The filter material technology is the key technology of the bag filter. The service life of filter material and dust removal efficiency are the most important factors of bag filter. Due to equipment, production technology and other conditions, the domestic filter material technology has lagged behind foreign countries for a long time. Especially in the high temperature filter material, foreign filter material has been filled with domestic filter material market, the foreign manufacturers are dominant from both filter material fiber to finished products of filter bag, such as PPS fiber has long been monopolized by Japan's Toyobo and Toray company. At present, bag dust removal technology can fully meet the requirements of dust removal and stable and reliable operation. The filter material is the key component of the bag filter, and its performance directly affects the filter effects and service life of the bag filter. Therefore, it is very important to develop high quality high temperature resistant filter materials.

The information disclosed in this background technology section is only intended to provide an understanding of the general background of this invention, and should not be construed as acknowledging or implying in any way that the information composition is the existing technology known to the general technical personnel in the field.

### SUMMARY OF THE INVENTION

The purpose of the invention is to provide a modified polylactic acid melt-blown fiber layer, overcoming the shortcomings of existing technologies.

The invention provides a melt-blown non-woven filter material, characterized in that: the melt-blown non-woven filter material is prepared by the following method: provide a polylactic acid raw material; dissolve the polylactic acid raw material into a DMF solvent to obtain a polylactic acid spinning solution, wherein the concentration of the polylactic acid is 10-15 wt %; the polylactic acid electrospinning layer is prepared by electrospinning method using polylactic acid spinning solution as raw material; provide polylactic acid raw material again and provide polyphenylene sulfide raw material; and perform surface treatment on the polylactic acid raw materials mentioned above; after surface treatment, polylactic acid raw material, polyphenylene sulfide raw material, nano-titania powder are mixed well with the processing assistant to obtain a mixture; the mixture is extruded into modified polylactic acid particles by an extrusion molding method; then a modified polylactic acid melt-blown fiber layer is formed on the polylactic acid electrospinning layer by using the melt-blown method.

Preferably, in the technical scheme mentioned above, the polylactic acid electrospinning layer is prepared by electrospinning method using polylactic acid spinning solution as raw material, and the specific methods are as follows: the spinning voltage is 26-30 kv, the extrusion speed of the spinning solution is 1-2 mL/h, and the receiving distance is 10-20 cm.

Preferably, in the technical scheme mentioned above, surface treatment performed on the polylactic acid raw materials is as follows specifically: a dilute solution of the silane coupling agent is provided, wherein the concentration of the silane coupling agent is 4-8 wt %; the polylactic acid raw materials are added into the dilute solution of the silane coupling agent to obtain a mixed solution, wherein the mass ratio of the polylactic acid and the silane coupling agent is 3:1-4:1; stir the mixed solution, wherein the stirring temperature is 60-80° C. and the stirring time is 10-20 h;

Preferably, in the technical scheme mentioned above, after the surface treatment, the polylactic acid raw materials account for 100-120 parts by weight, the polyphenylene sulfide raw materials account for 30-40 parts by weight, and the nano-titania powder accounts for 10-15 parts by weight.

Preferably, in the technical scheme mentioned above, the mixture is extruded into modified polylactic acid particles by an extrusion molding method, specifically: the temperature in the first zone of the screw extruder is 260-270° C., the second zone is 270-280° C., the third zone is 280-285° C., the fourth zone is 285-290° C., the fifth zone is 300-310° C., the sixth zone is 310-320° C., and the temperature of the die head is 300-310° C.

Preferably, in the technical scheme mentioned above, a modified polylactic acid melt-blown fiber layer is formed on the polylactic acid electrospinning layer by using the melt-blown method, specifically: the temperature in the first zone of the melt-blown devices screw extruder is 270-280° C., the second zone is 280-290° C., the third zone is 290-295° C., the fourth zone is 295-300° C., the fifth zone is 310-320° C., and the sixth zone is 320-330° C.

Preferably, in the technical scheme mentioned above, a modified polylactic acid melt-blown fiber layer is formed on the polylactic acid electrospinning layer by using the melt-blown method, specifically: the hot air pressure is 0.5-1 mpa, the hot air temperature is 310-320° C., and the receiving distance is 20-30 cm.

Compared with existing technology, the present invention has the following beneficial effects: the ideal performance of the air filter material is “high filtration efficiency, low filtration resistance”, and the current filter material cannot effectively achieve the requirements of “high filtration efficiency, low filtration resistance”. Although some filtration materials have high filtration efficiency, their high fiber density leads to high filtration resistance. In order to ensure the efficiency of gas circulation, it is necessary to increase the power of gas circulation device, which will lead to waste of energy. Some materials have low filtration resistance, but the filtration efficiency is also poor due to the large space between the material fibers. In order to give consideration to the factors of filtration efficiency and filtration resistance, this, present invention provides a melt-blown non-woven filter material, which uses an improved structure, an improved preparation method, and an improved composition. The inventor discovered that the synthetic fabric of PLA and PSS can more effectively “intercept” PM2.5 particles in the air. At the same time, the inventor innovatively realized to load nano titanium dioxide particles into the mixed fiber, which makes the fiber material of the invention not only have filtering effect, but also have photocatalytic ability and the inventor have innovatively realized the loading of nano titania particles in the synthetic fabric, which makes the fiber material of this invention not only have a filtering effects, but also has photocatalytic capabilities. Compared with the filter material in the exiting technology, the filtering material of the invention has better filtering effects.

### DETAILED DESCRIPTION OF THE PREFERRED EMBODIMENTS

The following implementations are provided in order to better illustrate this present invention, and to communicate the scope of the invention fully to the technical personnel in this field.

### Implementation Example 1

The melt-blown non-woven filter material is prepared by the following method: provide a polylactic acid raw material; dissolve the polylactic acid raw material into a DMF solvent to obtain a polylactic acid spinning solution, wherein the concentration of the polylactic acid is 10 wt %; the polylactic acid electrospinning layer is prepared by electrospinning method using polylactic acid spinning solution as raw material; provide polylactic acid raw material again and provide polyphenylene sulfide raw material; perform surface treatment on the polylactic acid raw materials; after surface treatment, polylactic acid raw material, polyphenylene sulfide raw material, nano-titania powder and processing assistant are mixed well to obtain a mixture; the mixture is extruded into modified polylactic acid particles by an extrusion molding method; then a modified polylactic acid melt-blown fiber layer is formed on the polylactic acid electrospinning layer by using the melt-blown method. The polylactic acid electrospinning layer is prepared by electrospinning method using polylactic acid spinning solution as raw material, and the specific methods are as follows: the spinning voltage is 26 kV, the extrusion, speed of the spinning solution is 1 mL/h, and the receiving distance is 10 cm. The surface treatment performed on the polylactic acid raw materials is as follows: a dilute solution of the silane coupling agent is provided, wherein the concentration of the silane coupling, agent is 4 wt %; the polylactic acid raw materials are added into the dilute solution of the silane coupling agent to obtain a mixed solution, wherein the mass ratio of the polylactic acid and the silane coupling agent is 3:1; stir the mixed solution, wherein the stirring temperature is 60° C. and the stirring time is 10 h; after the surface treatment, the polylactic acid raw materials account for 100 parts by weight the polyphenylene sulfide raw materials account for 30 parts by weight, and the nano-titania powder accounts for 10 parts by weight. The mixture is extruded into modified polylactic acid particles by an extrusion molding method, specifically: the temperature in the first zone of the screw extruder is 260° C., the second zone is 270° C., the third zone is 280° C., the fourth zone is 285° C., the fifth zone is 300° C., the sixth zone is 310° C., and the temperature of the die head is 300° C. A modified polylactic acid melt-blown fiber layer is formed on the polylactic acid electrospinning layer by using the melt-blown method, specifically: the temperature in the first zone of the melt-blown devices screw extruder is 270° C., the second zone is 280° C. the third zone is 290° C., the fourth zone is 295° C., the fifth zone is 310° C., and the sixth zone is 320° C. A modified polylactic acid melt-blown fiber layer is fanned on the polylactic acid electrospinning layer by using the melt-blown method, specifically: the hot air pressure is 0.5 MPa, the hot air temperature is 310° C., and the receiving distance is 20 cm.

### Implementation Example 2

The melt-blown non-woven filter material is prepared by the following method: provide a polylactic acid raw material; dissolve the polylactic acid raw material into a DMF solvent to obtain a polylactic acid spinning solution, wherein the concentration of the polylactic acid is 15 wt %; the polylactic acid electrospinning layer is prepared by electrospinning method using polylactic acid spinning solution as raw material; provide polylactic acid raw material again and provide polyphenylene sulfide raw material; perform surface treatment on the polylactic acid raw materials; after surface treatment, polylactic acid raw material, polyphenylene sulfide raw material, nano-titania powder and processing assistant are mixed well to obtain a mixture; the mixture is extruded into modified polylactic acid particles by an extrusion molding method; then a modified polylactic acid melt-blown fiber layer is formed on the polylactic acid electrospinning layer by using the melt-blown method. The polylactic acid electrospinning layer is prepared by electrospinning method using polylactic acid spinning solution as raw material, and the specific methods are as follows: the spinning voltage is 30 kV, the extrusion speed of the spinning solution is 2 mL/h, and the receiving, distance is 20 cm. The surface treatment performed on the polylactic acid raw materials is as follows: a dilute solution of the silane coupling agent is provided, wherein the concentration of the silane coupling agent is 8 wt %; the polylactic acid raw materials are added into the dilute solution of the silane coupling agent to obtain a mixed solution, wherein the mass ratio of the polylactic acid and the silane coupling agent is 4:1; stir the mixed solution, wherein the stirring temperature is 80° C. and the stirring time is 20 h; after the surface treatment, the polylactic acid raw materials account for 120 parts by weight, the polyphenylene sulfide raw materials account for 40 parts by weight, and the nano-titania powder accounts for 15 parts by weight. The mixture is extruded into modified polylactic acid particles by an extrusion molding method, specifically: the temperature in the first zone of the screw extruder is 270° C., the second zone is 280° C., the third zone is 285° C., the fourth zone is 290° C., the fifth zone is 310° C., the sixth zone is 320° C., and the temperature of the die head is 310° C. A modified polylactic acid melt-blown fiber layer is formed on the polylactic acid electrospinning layer by using the melt-blown method, specifically: the temperature in the first zone of the melt-blown devices screw extruder is 280° C. the second zone is 290° C., the third zone is 295° C., the fourth zone is 300° C., the fifth zone is 320° C., and the sixth zone is 330° C. A modified polylactic acid melt-blown fiber layer is formed on the polylactic acid electrospinning layer by using the melt-blown method, specifically: the hot air pressure is 1 MPa, the hot air temperature is 320° C., and the receiving distance is 30 cm.

### Implementation Example 3

The melt-blown non-woven filter material is prepared by the following method: provide a polylactic acid raw material; dissolve the polylactic acid raw material into a DMF solvent to obtain a polylactic acid spinning solution, wherein the concentration of the polylactic acid is 12 wt %; the polylactic acid electrospinning layer is prepared by electrospinning method using polylactic acid spinning solution as raw material; provide polylactic acid raw material again and provide polyphenylene sulfide raw material; perform surface treatment on the polylactic acid raw materials; after surface treatment, polylactic acid raw material, polyphenylene sulfide raw material, nano-titania powder and processing assistant are mixed well to obtain a mixture; the mixture is extruded into modified polylactic acid particles by an extrusion molding method; then a modified polylactic acid melt-blown fiber layer is formed on the polylactic acid electrospinning layer by using the melt-blown method. The polylactic acid electrospinning layer is prepared by electrospinning method using polylactic acid spinning solution as raw material, and the specific methods are as follows: the spinning voltage is 28 kV, the extrusion speed of the spinning solution is 1.5 mL/h, and the receiving, distance is 15 cm. The surface treatment performed on the polylactic acid raw materials is as follows: a dilute solution of the silane coupling agent is provided, wherein the concentration of the silane coupling agent is 6 wt %; the polylactic acid raw materials are added into the dilute solution of the silane coupling agent to obtain a mixed solution, wherein the mass ratio of the polylactic acid and the silane coupling agent is 3.5:1; stir the mixed solution, wherein the stirring temperature is 70° C. and the stirring time is 15 h; after the surface treatment, the polylactic acid raw materials account for 110 parts by weight, the polyphenylene sulfide raw materials account for 34 parts by weight, and the nano-titania powder accounts for 12 parts by weight. The mixture is extruded into modified polylactic acid particles by an extrusion molding method, specifically: the temperature in the first zone of the screw extruder is 265° C., the second zone is 275° C., the third zone is 283° C., the fourth zone is 288° C., the fifth zone is 305° C., the sixth zone is 315° C., and the temperature of the die head is 305° C. A modified polylactic acid melt-blown fiber layer is formed on the polylactic acid electrospinning layer by using the melt-blown method, specifically: the temperature in the first zone of the melt-blown devices screw extruder is 275° C., the second zone is 285° C., the third zone is 292° C., the fourth zone is 298° C., the fifth zone is 315° C., and the sixth zone is 325° C. A modified polylactic acid melt-blown fiber layer is formed on the polylactic acid electrospinning layer by using the melt-blown method, specifically: the hot air pressure is 0.8 MPa, the hot air temperature is 315° C., and the receiving distance is 25 cm.

### Implementation Example 4

The melt-blown non-woven filter material is prepared by the following method: provide a polylactic acid raw material; dissolve the polylactic acid raw material into a DMF solvent to obtain a polylactic acid spinning solution, wherein the concentration of the polylactic acid is 20 wt %; the polylactic acid electrospinning layer is prepared by electrospinning method using polylactic acid spinning, solution as raw material; provide polylactic acid raw material again and provide polyphenylene sulfide raw material; perform surface treatment on the polylactic acid raw materials; after surface treatment, polylactic acid raw material, polyphenylene sulfide raw material, nano-titania powder and processing assistant are mixed well to obtain a mixture; the mixture is extruded into modified polylactic acid particles by an extrusion molding method; then a modified polylactic acid melt-blown fiber layer is formed on the polylactic acid electrospinning layer by using the melt-blown method. The polylactic acid electrospinning layer is prepared by electrospinning method using polylactic acid spinning solution as raw material, and the specific methods are as follows: the spinning voltage is 35 kV, the extrusion speed of the spinning solution is 5 mL/h, and the receiving distance is 25 cm. The surface treatment performed on the polylactic acid raw materials is as follows: a dilute solution of the silane coupling agent is provided, wherein the concentration of the silane coupling agent is 6 wt %; the polylactic acid raw materials are added into the dilute solution of the silane coupling agent to obtain a mixed solution, wherein the mass ratio of the polylactic acid and the silane coupling agent is 3.5:1; stir the mixed solution, wherein the stirring temperature is 70° C. and the stirring time is 15 h; after the surface treatment, the polylactic acid raw materials account for 110 parts by weight, the polyphenylene sulfide raw materials account for 35 parts by weight, and the nano-titania powder accounts for 12 parts by weight. The mixture is extruded into modified polylactic acid particles by an extrusion molding method, specifically: the temperature in the first zone of the screw extruder is 265° C., the second zone is 275° C., the third zone is 283° C., the fourth zone is 288° C., the fifth zone is 305° C., the sixth zone is 315° C., and the temperature of the die head is 305° C. A modified polylactic acid melt-blown fiber layer is formed on the polylactic acid electrospinning layer by using the melt-blown method, specifically: the temperature in the first zone of the melt-blown devices screw extruder is 275° C. the second zone is 285° C., the third zone is 292° C., the fourth zone is 298° C., the fifth zone is 315° C., and the sixth zone is 325° C. A modified polylactic acid melt-blown fiber layer is formed on the polylactic acid electrospinning layer by using the melt-blown method, specifically: the hot air pressure is 0.8 MPa, the hot air temperature is 315° C., and the receiving distance is 25 cm.

### Implementation Example 5

The melt-blown non-woven filter material is prepared by the following method: provide a polylactic acid raw material; dissolve the polylactic acid raw material into a DMF solvent to obtain a polylactic acid spinning solution, wherein the concentration of the polylactic acid is 12 wt %; the polylactic acid electrospinning layer is prepared by electrospinning method using polylactic acid spinning solution as raw material; provide polylactic acid raw material again and provide polyphenylene sulfide raw material; perform surface treatment on the polylactic acid raw materials; after surface treatment, polylactic acid raw material, polyphenylene sulfide raw material, nano-titania powder and processing assistant are mixed well to obtain a mixture; the mixture is extruded into modified polylactic acid particles by an extrusion molding method; then a modified polylactic acid melt-blown fiber layer is formed on the polylactic acid electrospinning layer by using the melt-blown method. The polylactic acid electrospinning layer is prepared by electrospinning method using polylactic acid spinning solution as raw material, and the specific methods are as follows: the spinning voltage is 28 kV, the extrusion speed of the spinning solution is 1.5 mL/h, and the receiving distance is 15 cm. The surface treatment performed on the polylactic acid raw materials is as follows: a dilute solution of the silane coupling agent is provided, wherein the concentration of the silane coupling agent is 10 wt %; the polylactic acid raw materials are added into the dilute solution of the silane coupling agent to obtain a mixed solution, wherein the mass ratio of the polylactic acid and the silane coupling agent is 1:1; stir the mixed solution, wherein the stirring temperature is 100° C. and the stirring time is 30 h; after the surface treatment, the polylactic acid raw materials account for 130 parts by weight, the polyphenylene sulfide raw materials account for 10 parts by weight, and the nano-titania powder accounts for 5 parts by weight. The mixture is extruded into modified polylactic acid particles by an extrusion molding method, specifically: the temperature in the first zone of the screw extruder is 265° C., the second zone is 275° C., the third zone is 283° C., the fourth zone is 288° C., the fifth zone is 305° C. the sixth zone is 315° C., and the temperature of the die head is 305° C. A modified polylactic acid melt-blown fiber layer is formed on the polylactic acid electrospinning layer by using, the melt-blown method, specifically: the temperature in the first zone of the melt-blown devices screw extruder is 275° C., the second zone is 285° C., the third zone is 292° C., the fourth zone is 298° C., the fifth zone is 315° C., and the sixth zone is 325° C. A modified polylactic acid melt-blown fiber layer is formed on the polylactic acid electrospinning layer by using the melt-blown method, specifically: the hot air pressure is 0.8 MPa, the hot air temperature is 315° C., and the receiving distance is 25 cm.

### Implementation Example 6

The melt-blown non-woven filter material is prepared by the following method: provide a polylactic acid raw material; dissolve the polylactic acid raw material into a DMF solvent to obtain a polylactic acid spinning solution, wherein the concentration of the polylactic acid is 12 wt %; the polylactic acid electrospinning layer is prepared by electrospinning method using polylactic acid spinning solution as raw material; provide polylactic acid raw material again and provide polyphenylene sulfide raw material; perform surface treatment on the polylactic acid raw materials; after surface treatment, polylactic acid raw material, polyphenylene sulfide raw material, nano-titania powder and processing assistant are mixed well to obtain a mixture; the mixture is extruded into modified polylactic acid particles by an extrusion molding method; then a modified polylactic acid melt-blown fiber layer is formed on the polylactic acid electrospinning layer by using the melt-blown method. The polylactic acid electrospinning layer is prepared by electrospinning method using polylactic acid spinning solution as raw material, and the specific methods are as follows: the spinning voltage is 28 kV, the extrusion speed of the spinning solution is 1.5 mL/h, and the receiving distance is 15 cm. The surface treatment performed on the polylactic acid raw materials is as follows: a dilute solution of the silane coupling agent is provided, wherein the concentration of the silane coupling agent is 6 wt %; the polylactic acid raw materials are added into the dilute solution of the silane coupling agent to obtain a mixed solution, wherein the mass ratio of the polylactic acid and the silane coupling agent is 3.5:1; stir the mixed solution, wherein the stirring temperature is 70° C. and the stirring time is 15 h; after the surface treatment, the polylactic acid raw materials account for 110 parts by weight, the polyphenylene sulfide raw materials account for 35 parts by weight, and the nano-titania powder accounts for 12 parts by weight. The mixture is extruded into modified polylactic acid particles by an extrusion molding method, specifically: the temperature in the first zone of the screw extruder is 280° C., the second zone is 290° C., the third zone is 300° C., the fourth zone is 310° C., the fifth zone is 320° C., the sixth zone is 325° C., and the temperature of the die head is 310° C. A modified polylactic acid melt-blown fiber layer is formed on the polylactic acid electrospinning layer by using the melt-blown method, specifically: the temperature in the first zone of the melt-blown devices screw extruder is 275° C., the second zone is 285° C., the third zone is 292° C., the fourth zone is 298° C., the fifth zone is 315° C., and the sixth zone is 325° C. A modified polylactic acid melt-blown fiber layer is formed on the polylactic acid electrospinning layer by using the melt-blown method, specifically: the hot air pressure is 0.8 MPa, the hot air temperature is 315° C., and the receiving distance is 25 cm.

### Implementation Example 7

The melt-blown non-woven filter material is prepared by the following method: provide a polylactic acid raw material; dissolve the polylactic acid raw material into a DMF solvent to obtain a polylactic acid spinning solution, wherein the concentration of the polylactic acid is 12 wt %; the polylactic acid electrospinning layer is prepared by electrospinning method using polylactic acid spinning solution as raw material; provide polylactic acid raw material again and provide polyphenylene sulfide raw material; perform surface treatment on the polylactic acid raw materials; after surface treatment, polylactic acid raw material, polyphenylene sulfide raw material, nano-titania powder and processing assistant are mixed well to obtain a mixture; the mixture is extruded into modified polylactic acid particles by an extrusion molding method; then a modified polylactic acid melt-blown fiber layer is formed on the polylactic acid electrospinning layer by using the melt-blown method. The polylactic acid electrospinning layer is prepared by electrospinning method using polylactic acid spinning solution as raw material, and the specific methods are as follows: the spinning voltage is 28 kV, the extrusion speed of the spinning solution is 1.5 mL/h, and the receiving distance is 15 cm. The surface treatment performed on the polylactic acid raw materials is as follows: a dilute solution of the silane coupling agent is provided, wherein the concentration of the silane coupling agent is 6 wt %; the polylactic acid raw materials are added into the dilute solution of the silane coupling agent to obtain a mixed solution, wherein the mass ratio of the polylactic acid and the silane coupling agent is 3.5:1; stir the mixed solution, wherein the stirring temperature is 70° C. and the stirring time is 15 h; after the surface treatment, the polylactic acid raw materials account for 110 parts by weight, the polyphenylene sulfide raw materials account for 35 parts by weight, and the nano-titania powder accounts for 12 parts by weight. The mixture is extruded into modified polylactic acid particles by an extrusion molding method, specifically: the temperature in the first zone of the screw extruder is 265° C., the second zone is 275° C., the third zone is 283° C., the fourth zone is 288° C., the fifth zone is 305° C., the sixth zone is 315° C., and the temperature of the die head is 305° C. A modified polylactic acid melt-blown fiber layer is formed on the polylactic acid electrospinning layer by using the melt-blown method, specifically: the temperature in the first zone of the melt-blown devices screw extruder is 290° C., the second zone is 300° C., the third zone is 305° C., the fourth zone is 310° C., the fifth zone is 330° C., and the sixth zone is 340° C. A modified polylactic acid melt-blown fiber layer is fainted on the polylactic acid electrospinning layer by using the melt-blown method, specifically: the hot air pressure is 0.8 MPa, the hot air temperature is 315° C., and the receiving distance is 25 cm.

### Implementation Example 8

The melt-blown non-woven filter material is prepared by the following method: provide a polylactic acid raw material; dissolve the polylactic acid raw material into a DMF solvent to obtain a polylactic acid spinning solution, wherein the concentration of the polylactic acid is 12 wt %; the polylactic acid electrospinning layer is prepared by electrospinning method using polylactic acid spinning, solution as raw material; provide polylactic acid raw material again and provide polyphenylene sulfide raw material; perform surface treatment on the polylactic acid raw materials; after surface treatment, polylactic acid raw material, polyphenylene sulfide raw material, nano-titania powder and processing assistant are mixed well to obtain a mixture; the mixture is extruded into modified polylactic acid particles by an extrusion molding method; then a modified polylactic acid melt-blown fiber layer is formed on the polylactic acid electrospinning layer by using the melt-blown method. The polylactic acid electrospinning layer is prepared by electrospinning method using polylactic acid spinning solution as raw material, and the specific methods are as follows: the spinning voltage is 28 kV, the extrusion speed of the spinning solution is 1.5 mL/h, and the receiving, distance is 15 cm. The surface treatment performed on the polylactic acid raw materials is as follows: a dilute solution of the silane coupling agent is provided, wherein the concentration of the silane coupling agent is 6 wt %, the polylactic acid raw materials are added into the dilute solution of the silane coupling agent to obtain a mixed solution, wherein the mass ratio of the polylactic acid and the silane coupling agent is 3.5:1; stir the mixed solution, wherein the stirring temperature is 70° C. and the stirring time is 15 h; after the surface treatment, the polylactic acid raw materials account for 110 parts by weight, the polyphenylene sulfide raw materials account for 35 parts by weight, and the nano-titania powder accounts for 12 parts by weight. The mixture is extruded into modified polylactic acid particles by an extrusion molding method, specifically: the temperature in the first zone of the screw extruder is 265° C., the second zone is 275° C., the third zone is 283° C., the fourth zone is 288° C., the fifth zone is 305° C., the sixth zone is 315° C., and the temperature of the die head is 305° C. A modified polylactic acid melt-blown fiber layer is formed on the polylactic acid electrospinning layer by using the melt-blown method, specifically: the temperature in the first zone of the melt-blown devices screw extruder is 275° C., the second zone is 285° C., the third zone is 292° C., the fourth zone is 298° C., the fifth zone is 315° C., and the sixth zone is 325° C. A modified polylactic acid melt-blown fiber layer is formed on the polylactic acid electrospinning layer by using the melt-blown method, specifically: the hot air pressure is 1.5 MPa, the hot air temperature is 330° C., and the receiving distance is 10 cm.

Implementation examples 1-8 were subjected to a filtration efficiency and filtration resistance test, and the test method follows national standards. The test results were normalized based on example 1.

TABLE 1

| | filtration efficiency | filtration resistance |
|---|---|---|
| Implementation example 1 | 100% | 100% |
| Implementation example 2 | 105% | 98% |
| Implementation example 3 | 104% | 95% |
| Implementation example 4 | 78% | 134% |
| Implementation example 5 | 83% | 151% |
| Implementation example 6 | 72% | 169% |
| Implementation example 7 | 74% | 145% |
| Implementation example 8 | 77% | 140% |

The foregoing description is only some specific exemplary embodiments of the present invention, but the protection scope of the present invention is not limited to this. Any readily conceivable changes or replacement by a technician familiar with the technical field within the technical scope disclosed by the invention shall be covered by the protection of the invention. Therefore, the scope of the invention is intended to be limited by claims and their equivalents.

1. A melt-blown non-woven filter material, characterized in that: the melt-blown non-woven filter material mentioned in this patent is prepared by the following method:
Provide a polylactic acid raw material;
Dissolve the polylactic acid raw material into a DMF solvent to obtain a polylactic acid spinning solution, wherein the concentration of the polylactic acid is 10-15 wt %;
The polylactic acid electrospinning layer is prepared by electrospinning method using polylactic acid spinning solution as raw material;
Provide polylactic acid raw material again and provide polyphenylene sulfide raw material;
Perform surface treatment on the polylactic acid raw materials mentioned is above;
After surface treatment, polylactic acid raw material, polyphenylene sulfide raw material, nano-titania powder are mixed well with the processing assistant to obtain a mixture;
The mixture is extruded into modified polylactic acid particles by an extrusion molding method;
Then a modified polylactic acid melt-blown fiber layer is formed on the polylactic acid electrospinning layer by using the melt-blown method;

2. The melt-blown non-woven filter material mentioned in claim 1, characterized in that: the polylactic acid electrospinning layer is prepared by electrospinning method using polylactic acid spinning solution as raw material, specifically: the spinning voltage is 26-30 kv, the extrusion speed of the spinning solution is 1-2 mL/h, and the receiving distance is 10-20 cm.

3. The melt-blown non-woven filter material mentioned in claim 1, characterized in that: the surface treatment performed on the polylactic acid raw materials is as follows:
A dilute solution of the silane coupling agent is provided, wherein the concentration of the silane coupling agent is 4-8 wt %;
The polylactic acid raw materials are added into the dilute solution of the silane coupling agent to obtain a mixed solution, wherein the mass ratio of the polylactic acid and, the silane coupling agent is 3:1-4:1;
Stir the mixed solution, wherein the stirring temperature is 60-80° C. and the stirring time is 10-20 h.

4. The melt-blown non-woven filter material mentioned in claim 1, characterized in that: after the surface treatment, the polylactic acid raw materials account for 100-120 parts by weight, the polyphenylene sulfide raw materials account for 30-40 parts by weight, and the nano-titania powder accounts for 10-15 parts by weight.

5. The melt-blown non-woven filter material mentioned in claim 1, characterized in that: the mixture is extruded into modified polylactic acid particles by an extrusion molding method, specifically: the temperature in the first zone of the screw extruder is 260-270° C., the second zone is 270-280° C., the third zone is 280-285° C., the fourth zone is 285-290° C., the fifth zone is 300-310° C., the sixth zone is 310-320° C., and the temperature of the die head is 300-310° C.

6. The melt-blown non-woven filter material mentioned in claim 1, characterized in that: a modified polylactic acid melt-blown fiber layer is formed on the polylactic acid electrospinning layer by using the melt-blown method, specifically: the temperature in the first zone of the melt-blown devices screw extruder is 270-280° C., the second zone is 280-290° C., the third zone is 290-295° C., the fourth zone is 295-300° C., the fifth zone is 310-320° C., and the sixth zone is 320-330° C.

7. The melt-blown non-woven filter material mentioned in claim 6, characterized in that: a modified polylactic acid melt-blown fiber layer is formed on the polylactic acid electrospinning layer by using the melt-blown method, specifically: the hot air pressure is 0.5-1 mpa, the hot air temperature is 310-320° C., and the receiving distance is 20-30 cm.
